(19) United States
(12) Patent Application Publication
(10) Pub. No.: US 2022/0147910 A1
(43) Pub. Date: May 12, 2022

(54) System and Method for Localized Postage Generation

(71) Applicants: Salim Kara, North York (CA); Alnoor Kara, Vaughan (CA)

(72) Inventors: Salim Kara, North York (CA); Alnoor Kara, Vaughan (CA)

(73) Assignee: myiStamp, Inc., North York (CA)

(21) Appl. No.: 17/517,792

(22) Filed: Nov. 3, 2021

Related U.S. Application Data
(60) Provisional application No. 63/111,313, filed on Nov. 9, 2020.

(51) Int. Cl. G06Q 10/08; G06Q 50/32

(52) U.S. Cl. CPC G06Q 10/087; G06Q 2250/70; G06Q 2250/10; G06Q 50/32

(57) ABSTRACT

There are provided systems and methods for localized postage generation. The system including one or more processors in communication with a data storage, the system in communication with a postal server for registration, the one or more processors configured to execute: a postage module to receive from a user funds for postage to be added to a postage ledger, the funds for postage communicated to a postal service and added to an affiliated ledger; an input module to receive a request for postage from a user, the request including one or more parameters; a request module to deduct the associated funds from the postage ledger; and an indicia module to generate and output one or more indicia, the indicia including an encoded alphanumerical value that incorporates identifying information, the indicia being scannable by the postal service such that the associated funds are deducted from the affiliated ledger based on the identifying information.

### CLAIM OF PRIORITY AND CROSS-REFERENCE TO RELATED APPLICATION

The present application is related to U.S. Provisional Patent Application No. 63/111,313, filed Nov. 9, 2020, entitled “System and Method for Localized Postage Generation.” The present application hereby claims priority under 35 U.S.C. § 119(e) to U.S. Provisional Patent Application No. 63/111,313.

### BACKGROUND

To acquire postage for a letter or package, a person can either buy the associated postage from an appropriate postal outlet or print the associated postage directly. In order to print the associated postage directly, some postal organizations will allow postage provision directly to organizations, such as commercial businesses. However, this approach is typically restrictive and costly, and generally requires a computer, printer, authorized special labels, constant internet connection with a server, and a subscription.

### SUMMARY

There are provided systems and methods for localized postage generation. The system comprising one or more processors in communication with a data storage, the system in communication with a postal server for registration, the one or more processors configured to execute: a postage module to receive from a user funds for postage to be added to a postage ledger, the funds for postage communicated to a postal service and added to an affiliated ledger; an input module to receive a request for postage from a user, the request comprising one or more parameters; a request module to deduct the associated funds from the postage ledger; and an indicia module to generate and output one or more indicia, the indicia comprising an encoded alphanumerical value that incorporates identifying information, the indicia being scannable by the postal service such that the associated funds are deducted from the affiliated ledger based on the identifying information.

These and other aspects are contemplated and described herein. It will be appreciated that the foregoing summary sets out representative aspects of embodiments to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a diagram of a system for localized postage generation, according to an embodiment, with an operating environment;

FIG. 2 is a flowchart for a method for localized postage generation, according to an embodiment;

FIG. 3 is a diagram of an example embodiment of the system of FIG. 1 showing a smartphone computing device with a printing device;

FIG. 4 is a diagram of an example embodiment of the system of FIG. 1 showing a smartphone computing device;

FIG. 5A illustrates an example of a Datamatrix indicium in accordance with the system of FIG. 1;

FIG. 5B illustrates an example of a PDF417 barcode indicium in accordance with the system of FIG. 1; and

FIG. 5C illustrates an example of a Quick Response (QR) code indicium in accordance with the system of FIG. 1.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to postage systems and, more specifically, to a system and method for localized postage generation.

In some cases, commercial enterprises can rent postage meters that can print postage meter marks (referred to as “franking”). This arrangement is very convenient since postage can be applied and mailed directly without requiring a physical visit to a postal outlet for example, the U.S. Post Office. However, this arrangement requires a large standalone device to be rented and situated in an office, which is typically only suitable for larger enterprises.

In some cases, third parties can be used for printing postage stamps. In such cases, a computing device connects and sends information to a postage server operated by the third-party postage provider. Postage is paid for during this transaction and the postage server generates and returns a postage indicia or other information to the computing device. The computing device then creates and/or sends the postage indicia to a connected general-purpose printer and the stamp (for example, bar-coded stamp) is printed on an envelope, label, or package. The postage indicia can be referred to as “information based indicia (IBI)” or “Intelligent Mail Indicia (IMI)”, “PC Postage”, “NetStamps”, “electronic stamps,” “internet postage,” “online postage,” “online stamps,” “digital stamps,” and “digital postage.” However, this arrangement generally requires establishing a connection with the postage server whenever postage is required to be generated.

Advantageously, embodiments of the present disclosure use smartphones, or other local computing devices, to provide convenient, efficient, and localized postage generation. As described herein, the devices can purchase and print postage locally, only requiring communication with a postal server for registration (and in some cases, reauthorization). Using smart device capabilities, identification and location can be determined during postage generation; potentially restricting where and who is permitted to generate the postage. The present embodiments are particularly advantageous for people and employees who work from home or remotely, as they reduce cost, increase security, and improve efficiency and ease of generation/printing.

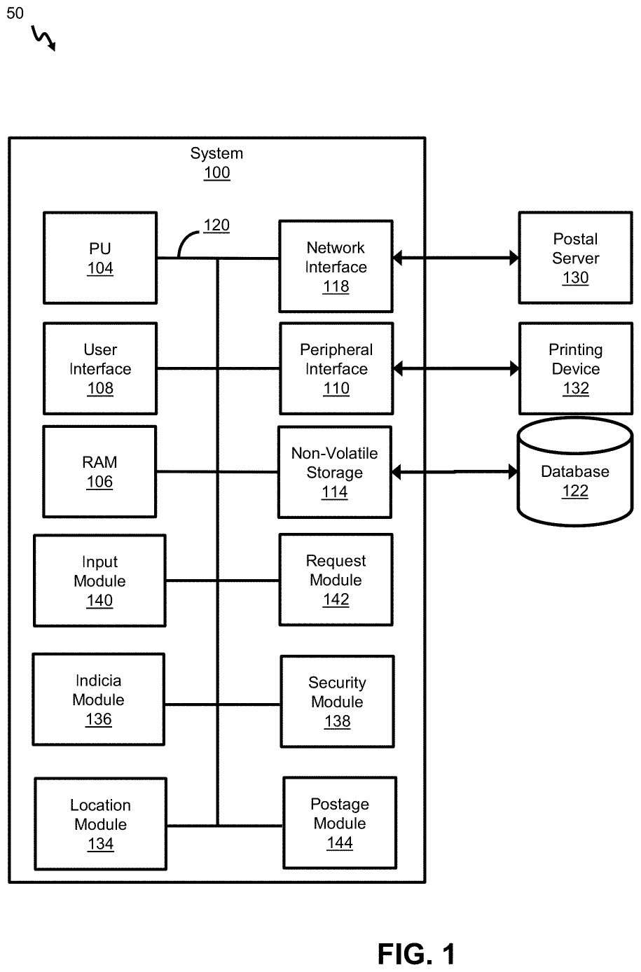

Referring now to FIG. 1, a system for localized postage generation 100, in accordance with an embodiment, is shown in the context of an operating environment 50. FIG. 1 shows various physical and logical components of an embodiment of the system 100. In some cases, the system can be part of a computing device, for example, a smartphone, tablet, laptop, desktop, or similar computing device. As shown, the system 100 includes a controller 102 that has a number of physical and logical components, including a processing unit (“PU”) 104 (comprising one or more processors), random access memory (“RAM”) 106, a user interface 108, a peripheral interface 110, non-volatile storage 114, a positioning module 116, a network interface 118, and a local bus 120 enabling the PU 104 to communicate with the other components. RAM 106 provides relatively responsive volatile storage to PU 104. The user interface 108 enables an administrator or user to provide input via an input device, for example a keyboard and mouse, or a touchscreen. The user interface 108 can also output information to output devices to the user, such as a display, speakers, or touchscreen. The network interface 118 permits communication with other systems, such as a postal server 130 over the Internet, and other servers remotely located from the system 100, such as cloud computing arrangement. The peripheral interface 110 permits the controller 102 to communicate with peripheral components of the system 100, such as a postage printing device 130, and/or with other computing devices. Non-volatile storage 114 stores the operating system and modules, including computer-executable instructions for implementing the operating system and modules, as well as any data used by these services. Additional stored data can be stored in a database 122. During operation of the system 100, the operating system, the modules, and the related data may be retrieved from the non-volatile storage 114 and placed in RAM 106 to facilitate execution.

The system 100 further includes a number of conceptual modules that can be executed on the PU 104; in an embodiment, an input module 140, a request module 142, and an indicia module 136. In some embodiments, the modules of the system 100 are stored by and executed on a single computing device. In other embodiments, the modules of the system 100 can be distributed among two or more computing devices that may be locally or remotely distributed; for example, some functions of the modules can be executed on the printing device 132 and/or the postal server 130. In some cases, the functions and/or operations of the modules can be combined or executed on other modules.

In most cases, the system 100 can be registered with a postage server prior to postage generation to authorize the system 100 for postage generation, where the postal server 130 can be located remotely and run by a relevant postal service or an authorized third-party postage provider. Advantageously, embodiments of the present disclosure only require Internet connectivity at the time of registration, and in some cases, periodically for validation or re-authorization. The registration can include the identifying information; for example, in the case of a smartphone, can include one or more of user's name, credit card, address, international mobile equipment identity (IMEI), phone number, Internet Protocol address, media access control (MAC) address, subscriber identification module (SIM) serial number, hardware serial number, or the like. With the identifying information, the postal server can create a unique customer identification (ID) with the associated identifying information.

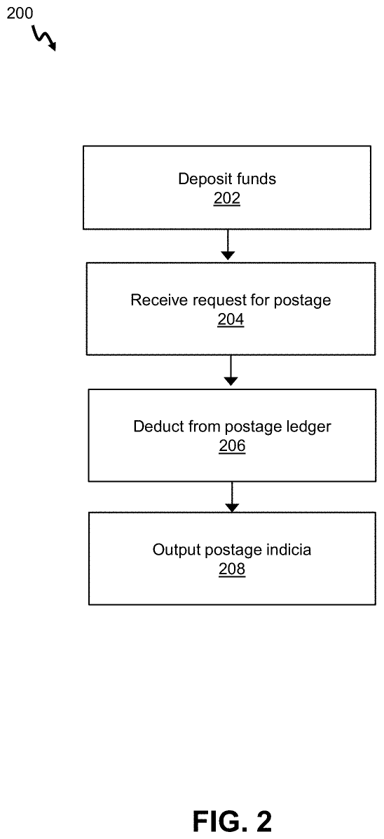

Referring now to FIG. 2, a method for localized postage generation 200, in accordance with an embodiment, is shown.

At block 202, the user, via the user interface 108, can use the postage module 144 to pre-purchase postage or deposit funds to be used for postage purchases, after having registered with the postal server 130. The postage module 144 can use a suitable payment protocol to communicate with the postal service, either directly or via the postal server 130, and the system 100 stores the associated amount of postage and/or monetary value for postage such that it is available to the user on a postal ledger stored on the system 100. The postal server and/or the postal service can also maintain an affiliated ledger based on the amount of postage purchased by the specific user. In some cases, third-party payment services (such as Apple Pay™, Google Pay™, etc.) can be used to mediate the transaction.

At block 204, the input module 140 receives a request for postage from the user interface 108. The request can include a desired postage or parameters that can be used to determine a desired postage, for example, stamp denomination, country, size, weight, postage class, quantity, and the like. In some cases, a scale can be associated with the system 100 to provide automatic weight input via the peripheral interface 110.

At block 206, the request module 142 fulfills the received request for postage by deducting the associated postage or amount of funds from the postal ledger. Where there is insufficient postage or amount of funds on the postal ledger, the request module 142 may indicate to the user that they are required to purchase additional postage or funds, as described at block 202.

Generally, the postage is embodied by one or more associated indicia. The indicia are generated by the system 100 when a user desires to use postage for mailing, and such indicia is associated with the object to be mailed, such as being affixed to the object. Advantageously, purchasing of postage can be handled locally by the postage module 144 without necessarily requiring connection to the postal server at the time of postage generation. Also advantageously, no financial information, such as credit card information, is necessarily stored by the system 100.

At block 208, the indicia module 136 generates one or more of the indicia. As described herein, the indicia can comprise an encoded alphanumerical value that incorporates identifying information, for example, the user ID, the postage value, printing date and time, geolocation, and/or the like. In some cases, the indicia module 136 can direct the peripheral interface 110 to print the postage indicia on the printing device 132. The printed indicia can then be affixed to the letter or package to be mailed to indicate that postage for mailing. The postal service can then authenticate the indicia by their relevant security standards, for example, by scanning the indicia and comparing it to a database of permissible indicia. The postal service can then cross reference the indicia using the information encoded or encompassed by the indicia; for example, using a unique ID, a user's unique ID, a unique stamp ID, a printed date, geofencing/geolocation information, or the like. Using this information, the postal service can update the affiliated ledger associated with that user by deducting the associated postage. In some cases, the postal service can use a database of all received indicia (or information encompassed by such indicia) to ensure there are not duplicates. In some cases, this cross referencing can occur when the mail or package is received and scanned, or at a mail sorting facility, or elsewhere.

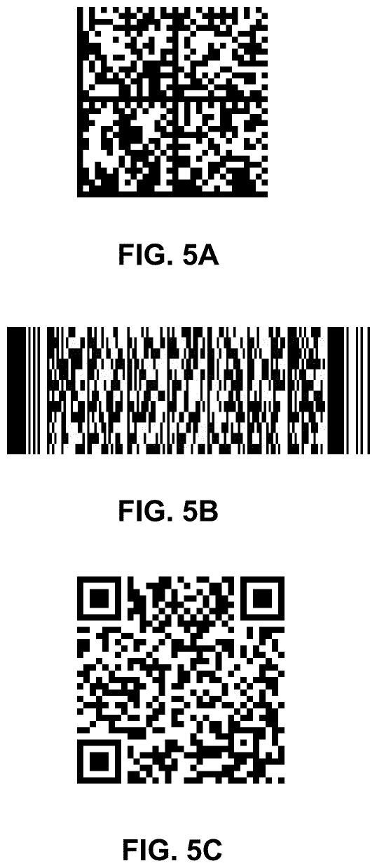

FIGS. 5A to 5C illustrate different examples of indicia. FIG. 5A illustrates an example of a Datamatrix indicium, FIG. 5B illustrates an example of a PDF417 barcode indicium, and FIG. 5C illustrates an example of a Quick Response (QR) code indicium. Each of these examples encode 60 alphanumeric characters (adjutr7654nkogrthi5678098765bcp56bgfedo67ads9mvtgolkjr54320z) for postal service identification and 10 extra characters.

In some cases, each label roll for the printing device 132 can be purchased and shipped to the user and include a serial number incorporated or embedded into an identifier; for example, a radio-frequency-identification (RFID) chip, barcode, or any other identifier. The serial number can also be pre-printed, inserted, or made part of, in whole or in part, with the label roll; for example, using ink, toner, tagging, marking, or the like. In some cases, when a new label roll is installed in the printing device 132, the serial number can be manually or automatically communicated to the system 100 via the peripheral interface 110. In some cases, the indicium could include the label roll serial number (fully or partially) in addition to additionally unique characters representing each individual postage of the roll, such as, for example, a unique hexadecimal number. In some cases, further information can be incorporated as part of the indicia such as, for example, the user's internet protocol (IP) address, the user's geolocation, identifying information of the printing device 132 connected to the system 100, and the like.

In some cases, location information determined by a location module 134, such as by using GPS location tracking or Wi-Fi location tracking, can be used for geotagging purposes to establish the location where the postage was printed. In some cases, geofencing may be used to control the location from which the postage is authorized to print for security purposes; for example, preventing printing outside of a predetermined geographical area. In other cases, where geolocation information is incorporated into the indicia, the postal service will only accept the mail or package having the indicia, upon scanning the indicia, if the geolocation information matches the location authorized for that user.

In an example, the extra characters in the indicia can be used for conveying extra information; for example, a website address, corporate info/message, personal info, message, product, service, games, advertisement, coupon, picture, and the like. In some cases, a separate tag, based on the extra characters, could be also printed to display the extra information. In an example, the separate tag could be a randomly generated number linked to a coupon and/or a prize. In another example, the separate tag could be an advertisement that is selected/preset per demography or based on other criteria. In some cases, the separate tag could be a scannable code that is intended to be scanned by a recipient of the mail or package associated with the postage. In some cases, the separate tag could be a hyperlink to a website that would reveal advertising or prize/coupon information. In an example, a recipient of a piece of mail, with the indicia affixed, could scan the indicia (for example, comprising a QR code) with their smartphone camera and be automatically directed to a coupon for their benefit.

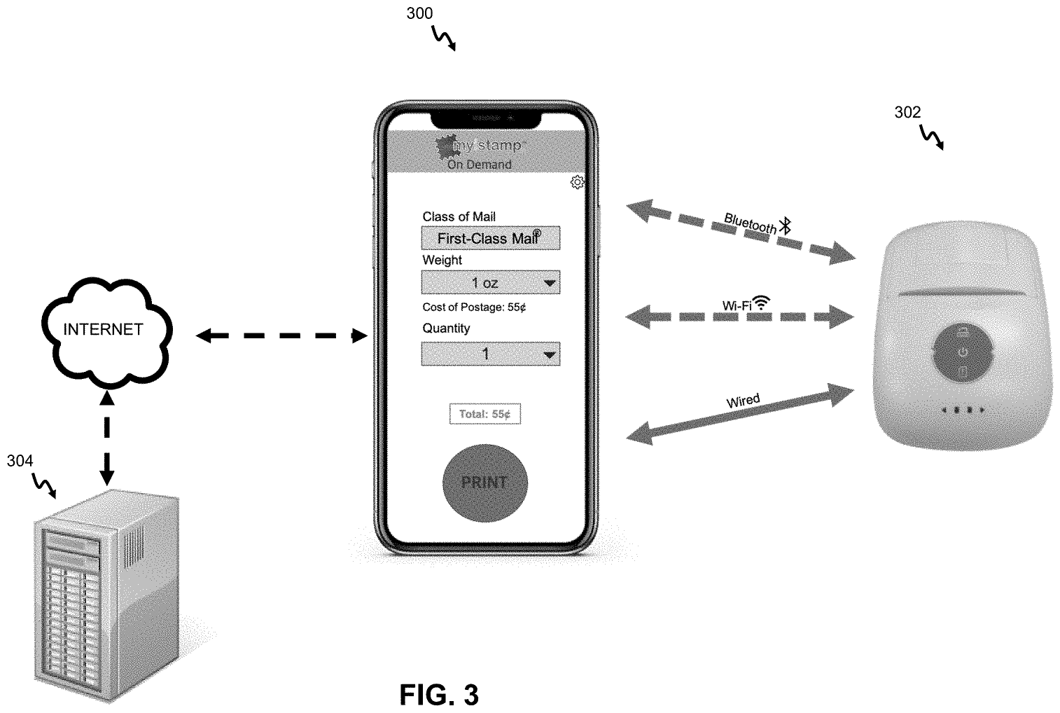

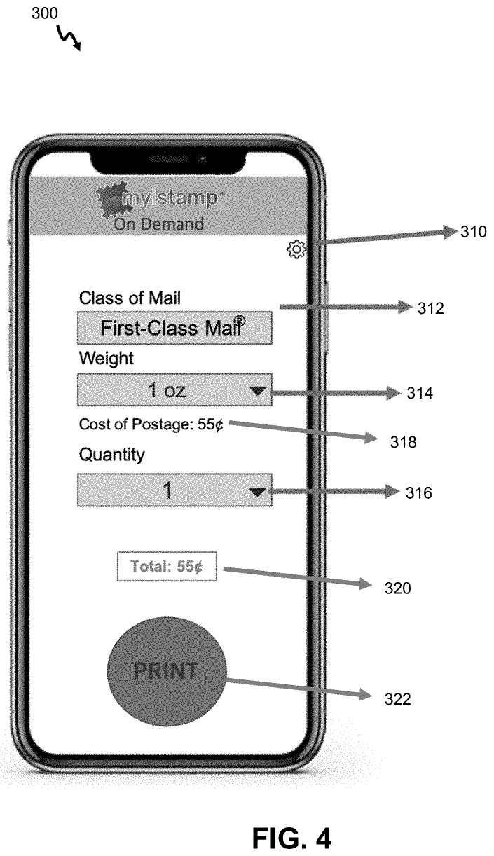

FIGS. 3 and 4 illustrate an example embodiment of the system 100. In this example, the system 100 is run on a smartphone 300 communicating with the associated printing device 132, which in this example comprises a postage printer 302. In this example, the specialized postage printer 302 is associated with the customer ID of the system 100 and connected via Bluetooth, Wi-Fi, ethernet, or the like. Due to its association with the customer ID, authorized users can print to the associated postage printer 302. Advantageously, the associated postage printer 302 is small, compact, and portable. Also illustrated is the smartphone's 300 connection with the postal server 304 via the Internet. As described, in most cases, this Internet connection is only required during registration and validation; and in some cases, during updating of postage rates, and for downloading any usage information as required by the postal authority at a predetermined time.

In the example of FIG. 4, the user interface 108 on the smartphone 300 touchscreen includes settings 310 to access account information, to pair the printer 302, and the like. It also includes inputs for parameters for the class of mail 312, weight 314, and quantity 316. As the inputs change, the user interface 108 can display the associated cost of postage 318 and total cost 320. Additionally, the user interface 108 can include an input 322 for generating the postage as per method 200.

In some cases, the system 100 can send a request to the postal server 130 to validate and authorize the system 100 at a predetermined interval (every day, every week, every month, etc.). After this set time period, the system 100 can cease functioning unless it connects to the postage server to re-authorize. Advantageously, the system 100 allows for automatic and immediate download of any postal rate change due to this periodic communication with the postal server 130. In some cases, activity associated with the postal ledger could be uploaded to the postal server 130 at a predetermined interval to cross reference with the affiliated ledger.

In some cases, remote accessibility could be provided in order to add/delete users, set limits, and audit usage history by individual, departments, and the like.

In some cases, for security purposes, some information can be restricted from the system 100 to be transmitted to the postal server 130 so no full set of data could be captured between the system 100 and the postal server 130. In order to complete the printing process, additional data stored on the system 100 could be added on the return packet from the server 130. In some cases, for the postal service to validate a postage, in addition to validating the indicia with their relevant security standards, as described herein, they can also cross-reference one or more of the unique ID, the user's unique ID, the unique stamp ID, date printed, geofencing data, or the like. In some cases, the postal service can maintain their own database of all printed postage and check for any duplicates using any of the identifiers.

In some cases, the system 100 can include a security module 138 operable to prevent unauthorized use of the system 100. In various examples, the security module 138 can comprise a biometric sensor, face-matching unlocking, password/passcode unlocking, or the like.

Advantageously, the system 100 can require no internet connection to the postal server 130 to generate the postage; whereby the system 100 can itself generate, digitally sign, and print on demand. Thus, providing a more efficient, convenient, faster, and secure approach for the user and for the postal service.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

1. A system for localized postage generation, the system comprising one or more processors in communication with a data storage, the system configured to enable communication with a postal service server, the one or more processors configured to execute:
a postage module to receive from a user funds for postage to be added to a postage ledger;
an input module to receive a postage request from a user;
a request module to deduct, from the postage ledger, postage funds corresponding to the postage request; and
an indicia module configured to generate and output one or more indicia processable by the postal service to effect mailing of an object.

2. The system of claim 1, wherein the postage funds are communicated to the postal server and reconciled against an affiliated ledger.

3. The system of claim 1, wherein the one or more indicia comprise an electronically scannable indicium.

4. The system of claim 3, wherein the electronically scannable indicium comprises a Datamatrix indicium.

5. The system of claim 3, wherein the electronically scannable indicium comprises a Quick Response (QR) Code indicium.

6. The system of claim 3, wherein the electronically scannable indicium comprises a barcode indicium.

7. The system of claim 1, wherein the system maintains communication with the postal server only for registration of a user.

8. The system of claim 1, wherein the system maintains communication with the postal server only for registration of a user or validation of a user's account.

9. The system of claim 1, wherein the postage module is operable to receive from a user funds for postage to be added to a postage ledger, without communication between the system and the postal server.

10. The system of claim 1, the request module is operable to deduct, from the postage ledger, postage funds corresponding to the postage request, without communication between the system and the postal server.

11. The system of claim 1, the indicia module is operable to generate and output one or more indicia processable by the postal service to effect mailing of an object, without communication between the system and the postal server.

12. The system of claim 1, further comprising a printer for printing the one or more indicia, and a location module for determining a location of printing of the one or more indicia,

13. The system of claim 12, wherein the system is operable to establish geofencing information based on the determination made by the location module, the geofencing information controlling authorization for the printer to print the one or more indicia.

14. The system of claim 12, wherein the system is operable to establish geofencing information based on the determination made by the location module, the geofencing information used to establish an acceptable mailing location for mailing an object bearing the one or more indicia.

15. A method for generating localized postage using a system comprising one or more processors in communication with a data storage, the system being configured to enable communication with a postal service server, the method comprising:
receiving, from a user, funds for postage to be added to a postage ledger;
receiving a postage request from a user;
deducting, from the postage ledger, postage funds corresponding to the postage request; and
generating and outputting one or more indicia processable by the postal service to effect mailing of an object.

16. The method of claim 15, further comprising printing the one or more indicia for affixation to the object.

17. The method of claim 15, wherein the step of receiving, from the user, funds for postage to be added to a postage ledger, is accomplished without communication between the system and the postal server.

18. The method of claim 15, wherein the step of deducting, from the postage ledger, postage funds corresponding to the postage request, is accomplished without communication between the system and the postal server.

19. The method of claim 15, wherein the step of generating and outputting one or more indicia is accomplished without communication between the system and the postal server.
